(19) United States
(12) Patent Application Publication
(10) Pub. No.: US 2026/0339289 A1
(43) Pub. Date: Oct. 29, 2026

(54) NUMERICAL CONTROL DEVICE

(71) Applicant: FANUC CORPORATION, Minamitsuru-gun, Yamanashi (JP)

(72) Inventor: Daiki KIKKAWA, Yamanashi (JP)

(73) Assignee: FANUC CORPORATION, Minamitsuru-gun, Yamanashi (JP)

(21) Appl. No.: 19/111,651

(22) PCT Filed: Dec. 16, 2022
(86) PCT No.: PCT/JP2022/046350

§ 371 Date: Mar. 13, 2025

(51) Int. Cl. G05B 19/402; G05B 19/401

(52) U.S. Cl. CPC G05B 19/402; G05B 19/401; G05B 2219/37397

(57) ABSTRACT

A numerical control device according to one embodiment of the present disclosure is equipped with: an ideal specified value group calculation unit for calculating an ideal specified value group, which is a specified value group comprising one or more numerical values which specify a location which is offset from a machining point by only a prescribed set distance in a direction which is perpendicular to the workpiece surface, on the basis of a detected value from a gap detector, for each control period; and an actual specified value group calculation unit which calculates an actual specified value group, which is a specified value group which represents the location at which a machining head is actually positioned, on the basis of the ideal specified value group. Therein, the actual specified value group calculation unit sets the current actual specified value group so as to be a specified value group identical to the current ideal specified value group when an assessment value which expresses the relationship of the current ideal specified value group to the actual specified value group of the previous one period is less than or equal to a prescribed reference value, and sets the current actual specified value group so as to be a specified value group for which the distance from the machining point is a set distance and the assessment value is equal to the reference value when the current ideal specified value group exceeds the reference value.

### TECHNICAL FIELD

The present invention relates to a numerical control device.

### BACKGROUND ART

Generally, when machining a workpiece by moving a machining head and the workpiece relative to each other, it is required to offset the machining head by a constant distance from the workpiece. For example, in laser machining, it is desirable to maintain the offset distance of the machining head with relatively high precision in accordance with the focal length of the laser. In order to precisely keep the machining head offset at a constant distance, it has been proposed to detect the distance between the machining head and the workpiece using a detector provided on the machining head, and to adjust the position of the machining head so that the distance between the machining head and the workpiece is kept constant (see, for example, Patent Document 1).

### CITATION LIST

### Patent Document

Patent Document 1: Japanese Unexamined Patent Application, Publication No. 2017-192970

### DISCLOSURE OF THE INVENTION

### Problems to be Solved by the Invention

It is desirable to offset the machining head in the normal direction at a machining point on the surface of the workpiece. Depending on the surface shape of the workpiece, the normal direction at the machining point can change abruptly, which may cause abnormal vibration in the machining device.

### Means for Solving the Problems

A numerical control device according to an embodiment of the present disclosure is a numerical control device for controlling a machining device including a machining head that machines a workpiece, a drive mechanism that moves the workpiece and the machining head relative to each other, and a gap detector that detects a distance between the workpiece and the machining head, the numerical control device including: a movement control unit configured to move the workpiece and the machining head relative to each other so as to change a position of a machining point on the workpiece where the machining is performed by the machining head; an ideal specification value group calculation unit configured to calculate an ideal specification value group for each control cycle based on a value detected by the gap detector, the ideal specification value group being a specification value group including one or more numerical values that specify a position where the machining head is offset by a preset distance in a direction perpendicular to a surface of the workpiece from the machining point; and an execution specification value group calculation unit configured to calculate an execution specification value group based on the ideal specification value group, the execution specification value group being a specification value group that indicates a position where the machining head is actually placed, wherein the execution specification value group calculation unit sets the execution specification value group in a current cycle to the same specification value group as the ideal specification value group in the current cycle if an evaluation value indicating a relationship of the ideal specification value group in the current cycle to the execution specification value group in an immediately preceding cycle is equal to or less than a predetermined reference value, and sets the execution specification value group in the current cycle to a specification value group that allows the distance from the machining point to be the preset distance and the evaluation value to be equal to the reference value if the evaluation value of the ideal specification value group in the current cycle is greater than the reference value.

### BRIEF DESCRIPTION OF THE DRAWINGS

FIG. 1 is a diagram schematically illustrating a configuration of a machining system including a numerical control device according to an embodiment of the present disclosure; and

FIG. 2 is a diagram schematically illustrating a relationship between an ideal specification value group and an execution specification value group calculated by the numerical control device shown in FIG. 1.

### PREFERRED MODE FOR CARRYING OUT THE INVENTION

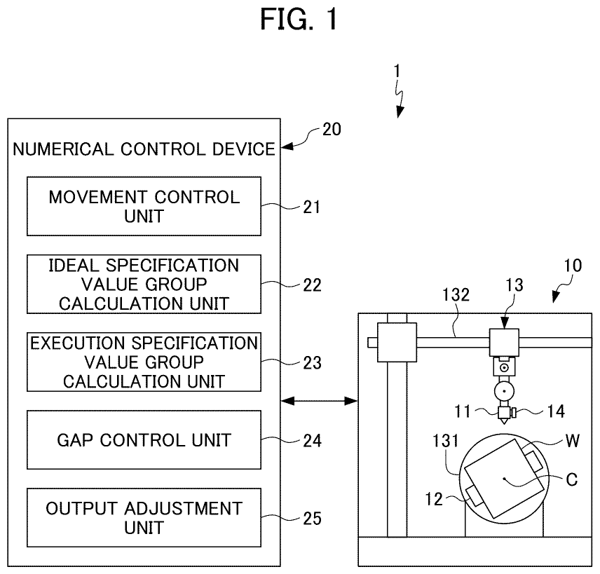

The following describes an embodiment of the present disclosure with reference to the drawings. FIG. 1 is a diagram schematically illustrating a configuration of a machining system 1 including a numerical control device 20 according to an embodiment of the present disclosure. The machining system 1 includes a machining device 10 and the numerical control device 20 that controls the machining device 10.

The machining device 10 includes a machining head 11 that machines a workpiece W, a workpiece holding unit 12 that holds the workpiece W, a drive mechanism 13 that moves the workpiece W held by the workpiece holding unit 12 and the machining head 11 relative to each other, and a gap detector 14 that detects the distance between the workpiece W and the machining head 11.

The machining head 11 may be, for example, a laser head that irradiates the workpiece W with laser, a cutting head having a rotary tool, or the like. Preferably, the machining system 1 has a configuration in which the output of the machining head 11, that is, the intensity of laser light and the torque of the rotary tool, for example, can be adjusted by the numerical control device 20.

The workpiece holding unit 12 may have any configuration as long as the workpiece holding unit 12 can hold the workpiece W, and may include, for example, a table and a chuck. In the embodiment shown in FIG. 1, the workpiece holding unit 12 is contemplated to have a chuck that holds the workpiece W and is rotated by the drive mechanism 13.

The drive mechanism 13 is configured to be able to move the machining head 11 and the workpiece W relative to each other so as to move a machining point where the machining of the workpiece W is performed by the machining head 11. In the present embodiment, the drive mechanism 13 includes a rotary drive mechanism 131 that rotates the workpiece W by rotating the workpiece holding unit 12 so as to change the position of the machining point on the workpiece W to which the machining head 11 is opposed. In the embodiment shown in FIG. 1, the rotary drive mechanism 131 rotates the workpiece W being held by the workpiece holding unit 12 around an axis C perpendicular to the plane of FIG. 1. The drive mechanism 13 is configured to be able to adjust the distance between the machining head 11 and the workpiece W. In the present embodiment, the drive mechanism 13 includes a Cartesian coordinate system drive mechanism 132 having a plurality of drive axes for changing the position and the orientation of the machining head 11. It should be noted that the drive mechanism 13 is not limited to the configuration described above and may have any configuration such as a configuration including, for example, an articulated robot that moves the machining head 11 or the workpiece holding unit 12.

Preferably, the gap detector 14 is provided on the machining head 11 in order to measure the distance between the machining head 11 and the workpiece W with high accuracy. Examples of devices usable as the gap detector 14 include a capacitance sensor, a laser sensor, and an ultrasonic sensor.

The numerical control device 20 can be implemented through one or more computer devices that have memory, a processor (CPU), an input/output interface, and the like, and execute an appropriate control program. The constituent elements of the numerical control device 20 described below are distinguishable based on different functions of the numerical control device 20 (operations of the processor), and do not have to be clearly distinguishable in terms of physical configuration and program configuration.

The numerical control device 20 includes a movement control unit 21, an ideal specification value group calculation unit 22, an execution specification value group calculation unit 23, a gap control unit 24, and an output adjustment unit 25.

The movement control unit 21 moves the workpiece W and the machining head 11 relative to each other so as to change the position of the machining point on the workpiece W where the machining is performed by the machining head 11. In the present embodiment, the movement control unit 21 is contemplated to move the position of the machining point opposite the machining head 11 by rotating the chuck of the workpiece holding unit 12, and thus rotating the workpiece W around the axis C. However, the movement control unit 21 may move the machining point by operating the machining device 10 so as to change the position of at least one of the workpiece W or the machining head 11.

The ideal specification value group calculation unit 22 calculates an ideal specification value group for each control cycle based on a value detected by the gap detector 14. The ideal specification value group is a specification value group including one or more numerical values that specify a position where the machining head 11 is offset by a preset distance in a direction perpendicular to the surface of the workpiece W from the machining point, which in other words, is an ideal position of the machining head 11. The position of the machining head 11 may be defined as the position of the tip of the body of the machining head 11 excluding a tool and the like. It should be noted that the “specification value group” is a set of one or more numerical values representing a position of the machining head 11, and may be, for example, a single angle or vector with respect to the position of the machining point, or coordinates in a non-moving coordinate system. Preferably, in order to facilitate determination of the movement of the machining head 11 for each control cycle, the “specification value group” is a vector originating from the position of the machining point.

The ideal specification value group calculation unit 22 calculates the orientation of the machining head 11 at the machining point on the surface of the workpiece W by taking into account the movement of the machining head 11 and the workpiece W. Specifically, the ideal specification value group calculation unit 22 can identify where the machining point from the immediately preceding cycle is currently located based on the value detected by the gap detector 14 in the immediately preceding cycle, the value detected by the gap detector 14 in the current cycle, and the amount of movement of the machining head 11 and the workpiece W from the immediately preceding cycle to the current cycle. Furthermore, the ideal specification value group calculation unit 22 can calculate a position separated by the present distance from the machining point using the slope of a straight line connecting the machining point in the immediately preceding cycle and the machining point in the current cycle as the surface direction of the workpiece W at the machining point in the current cycle.

The execution specification value group calculation unit 23 calculates an execution specification value group based on the ideal specification value group. The execution specification value group is a specification value group that indicates a position where the machining head 11 is actually placed. If the position indicated by the ideal specification value group in the current cycle and the position indicated by the execution specification value group in the immediately preceding cycle are far apart, the execution specification value group calculation unit 23 sets the execution specification value group to a group of values that specifies a position closer to the position indicated by the execution specification value group in the immediately preceding cycle than the position indicated by the ideal specification value group in the current cycle. Thus, abrupt movement of the machining head 11 is suppressed, preventing abnormal vibration in the machining device 10.

Specifically, the execution specification value group calculation unit 23 is configured to set the execution specification value group in the current cycle to the same specification value group as the ideal specification value group in the current cycle if an evaluation value indicating a relationship of the ideal specification value group in the current cycle to the execution specification value group in the immediately preceding cycle is equal to or less than a predetermined reference value, and set the execution specification value group in the current cycle to a specification value group that allows the distance from the machining point to be the preset distance and the evaluation value to be equal to the reference value if the evaluation value of the ideal specification value group in the current cycle is greater than the reference value.

The “evaluation value” is relatively simple and can be, for example, the angular difference between the vector corresponding to the ideal specification value group and the vector corresponding to the execution specification value group, the magnitude of the vector difference between the vector corresponding to the ideal specification value group and the vector corresponding to the execution specification value group, or the distance between the position indicated by the ideal specification value group and the position indicated by the execution specification value group. In particular, the amount of movement of the machining head 11 can be determined relatively easily and accurately by calculating the vector angular difference as the evaluation value. In this case, the reference value is the upper limit value of the angular difference between the vector corresponding to the ideal specification value group and the vector corresponding to the execution specification value group. However, for the user's ease in setting the reference value, the reference value may be calculated from a value set by the user as the upper limit value of the distance between the position of the machining head 11 indicated by the ideal specification value group in the current cycle and the position of the machining head 11 indicated by the execution specification value group in the immediately preceding cycle.

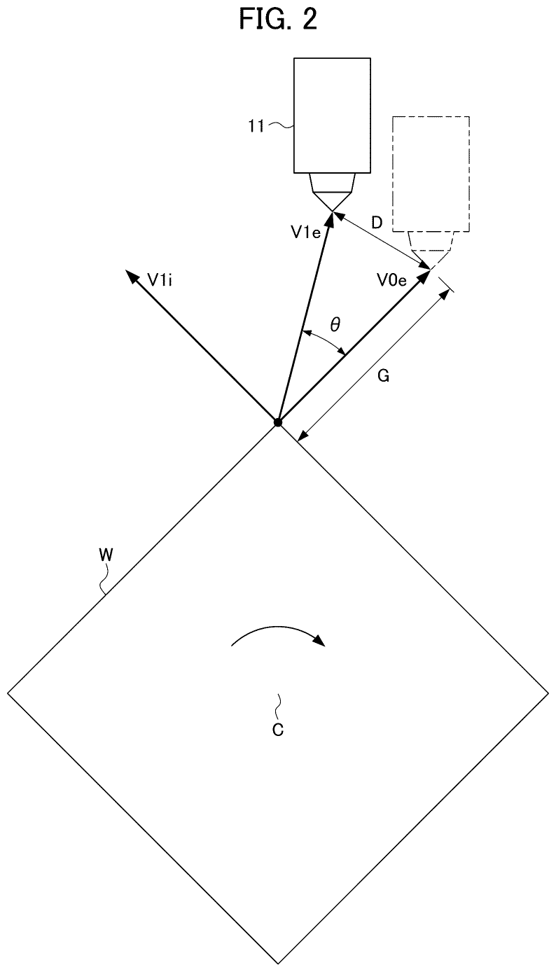

Referring to FIG. 2, the following describes in further detail an example of a method by which the execution specification value group calculation unit 23 calculates a specification value group that allows the distance from the machining point to be the preset distance and the vector angular difference, which is the evaluation value, to be equal to the reference value. In this example, the specification value group is a three-dimensional vector from the machining point to the position where the machining head 11 is placed. FIG. 2 shows an example in which the machining point moves through the rotation of the workpiece W, and the orientation of the surface of the workpiece W at the machining point and the moving speed of the machining point vary because the workpiece W has corners.

In FIG. 2, the vector corresponding to the ideal specification value group in the current cycle is represented by V1i, the vector corresponding to the execution specification value group that matches the ideal specification value group in the immediately preceding cycle is represented by V0e, and the vector corresponding to the newly set execution specification value group is represented by V1e, and X, Y, and Z-direction components of each vector are distinguished from each other using subscripts x, y, and z. The reference value for the vector angular difference is represented by θ.

The vector V1e corresponding to the new execution specification value group is calculated by rotating the vector V0e corresponding to the execution specification value group in the immediately preceding cycle by the angle θ, which is the reference value, around an axis perpendicular to both the vector V0e and the vector V1i corresponding to the ideal specification value group in the current cycle. To this end, first, a vector ver that serves as the axis around which the vector V0e is rotated is calculated as the cross product between the vector V0e and the vector V1i as in Formula 1 shown below.

$$[ \begin{matrix}{ver}_{x} \\ {ver}_{y} \\ {ver}_{z}\end{matrix} ] = [ \begin{matrix}V 1 {i}_{x} \\ V 1 {i}_{y} \\ V 1 {i}_{z}\end{matrix} ] \times [ \begin{matrix}V 0 {e}_{x} \\ V 0 {e}_{y} \\ {V0e}_{z}\end{matrix} ] = [ \begin{matrix}V 1 {i}_{y} V 0 {e}_{z} - V 1 {i}_{z} V 0 {e}_{y} \\ V 1 {i}_{z} V 0 {e}_{x} - V 1 {i}_{x} V 0 {e}_{z} \\ V 1 {i}_{x} V 0 {e}_{y} - V 1 {i}_{y} V 0 {e}_{x}\end{matrix} ] \qquad [ Formula 1 ]$$

Then, a magnitude norm of the vector ver is calculated as in Formula 2 shown below, and the vector ver is converted to a unit vector Vu by dividing each component of the vector ver by the magnitude norm of the vector as in Formula 3 shown below.

$$norm = \sqrt{{Vr}_{x}^{2} + {Vr}_{y}^{2} + {Vr}_{z}^{2}} \qquad [ Formula 2 ]$$

$$[ \begin{matrix}V {u}_{x} \\ V {u}_{y} \\ V {u}_{z}\end{matrix} ] = [ \begin{matrix}V {r}_{x} / norm \\ V {r}_{y} / norm \\ V {r}_{z} / norm\end{matrix} ] \qquad [ Formula 3 ]$$

The vector V1e corresponding to the execution specification value group in the current control cycle can be calculated by rotating the vector V0e by the angle θ using the unit vector Vu as in Formula 4 shown below.

$$[ \begin{matrix}V 1 {e}_{x} \\ V 1 {e}_{y} \\ V 1 {e}_{z}\end{matrix} ] = [ \begin{matrix}V {u}_{x}^{2} ( 1 - cos θ ) + cos θ & V {u}_{x} {Vu}_{y} ( 1 - cos θ ) - {Vu}_{z} sin θ & V {u}_{x} {Vu}_{z} ( 1 - cos θ ) + {Vu}_{y} sin θ \\ V {u}_{x} {Vu}_{y} ( 1 - cos θ ) + {Vu}_{z} sin θ & V {u}_{y}^{2} ( 1 - cos θ ) + cos θ & V {u}_{y} {Vu}_{z} ( 1 - cos θ ) - {Vu}_{x} sin θ \\ V {u}_{x} V {u}_{z} ( 1 - cos θ ) - {Vu}_{y} sin θ & {Vu}_{y} V {u}_{z} ( 1 - cos θ ) + V {u}_{x} sin θ & V {u}_{z}^{2} ( 1 - cos θ ) + cos θ\end{matrix} ] [ \begin{matrix}V 0 {e}_{x} \\ V 0 {e}_{y} \\ V 0 {e}_{z}\end{matrix} ] \qquad [ Formula 4 ]$$

In a case where the reference value is given as an upper limit value D of the distance between the position of the machining head 11 indicated by the vector V1i corresponding to the ideal specification value group in the current cycle (end point of the vector V1i) and the position of the machining head 11 indicated by the vector V0e corresponding to the execution specification value group in the immediately preceding cycle (end point of the vector V0e), the angular difference e between the vectors can be expressed by Formula 5 shown below, where G is the preset distance.

$$θ = {cos}^{- 1} ( \frac{2 {G}^{2} - {D}^{2}}{2 {G}^{2}} ) \qquad [ Formula 5 ]$$

The gap control unit 24 places the machining head 11 at the position indicated by the execution specification value group in the current cycle. More specifically, the gap control unit 24 calculates a driving amount for each axis of the drive mechanism 13 necessary to place the machining head 11 at the position indicated by the execution specification value group in the current cycle, and controls the drive mechanism 13.

The output adjustment unit 25 calculates the moving speed of the machining point at the moment the machining head 11 passes through the position indicated by the execution specification value group, and adjusts the output of the machining head, taking into account the moving speed of the machining point. More specifically, the output adjustment unit 25 reduces the output of the machining head, which is, for example, the intensity of the laser, if the moving speed of the machining point is low, and increases the output of the machining head if the moving speed of the machining point is high. Thus, the degree of machining of the workpiece W at the machining point can be maintained uniform.

As described above, the machining system 1 including the numerical control device 20 can reduce the amount of movement of the machining head 11 in one control cycle, thereby reducing vibration and achieving accurate machining.

The following further discloses additional remarks regarding the foregoing embodiment and modification examples thereof.

### (Additional Remark 1)

A numerical control device (20) is a numerical control device (20) for controlling a machining device (11) including a machining head (11) that machines a workpiece (W), a drive mechanism (13) that moves the workpiece (W) and the machining head (11) relative to each other, and a gap detector (14) that detects a distance between the workpiece (W) and the machining head (11), the numerical control device (20) including: a movement control unit (21) configured to move the workpiece (W) and the machining head (11) relative to each other so as to change a position of a machining point on the workpiece where the machining is performed by the machining head (11); an ideal specification value group calculation unit (22) configured to calculate an ideal specification value group for each control cycle based on a value detected by the gap detector (14), the ideal specification value group being a specification value group including one or more numerical values that specify a position where the machining head (11) is offset by a preset distance in a direction perpendicular to a surface of the workpiece (W) from the machining point; and an execution specification value group calculation unit (23) configured to calculate an execution specification value group based on the ideal specification value group, the execution specification value group being a specification value group that indicates a position where the machining head (11) is actually placed, wherein the execution specification value group calculation unit (23) sets the execution specification value group in a current cycle to the same specification value group as the ideal specification value group in the current cycle if an evaluation value indicating a relationship of the ideal specification value group in the current cycle to the execution specification value group in an immediately preceding cycle is equal to or less than a predetermined reference value, and sets the execution specification value group in the current cycle to a specification value group that allows the distance from the machining point to be the preset distance and the evaluation value to be equal to the reference value if the evaluation value of the ideal specification value group in the current cycle is greater than the reference value.

### (Additional Remark 2)

In the numerical control device (20) according to the additional remark 1, the ideal specification value group and the execution specification value group may be each a vector from the machining point to the position of the machining head (11).

### (Additional Remark 3)

In the numerical control device (20) according to the additional remark 2, the evaluation value may be an angular difference between the vector corresponding to the ideal specification value group and the vector corresponding to the execution specification value group.

### (Additional Remark 4)

In the numerical control device (20) according to the additional remark 3, the reference value may be calculated from a value set as an upper limit value of the distance between the position of the machining head (11) indicated by the ideal specification value group in the current cycle and the position of the machining head (11) indicated by the execution specification value group in the immediately preceding cycle.

### (Additional Remark 5)

The numerical control device (20) according to any one of the additional remarks 1 to 4 may further include an output adjustment unit (25) configured to calculate a moving speed of the machining point at the moment the machining head (11) passes through the position indicated by the execution specification value group, and adjust an output of the machining head (11), taking into account the moving speed of the machining point.

Although the present disclosure has been described in detail above, the present disclosure is not limited to the foregoing individual embodiments. Various changes, such as additions, substitutions, alterations, and partial omissions, may be made to the foregoing embodiments to the extent that such changes do not depart from the gist of the present disclosure, or to the extent that such changes do not depart from the gist of the present disclosure that is derived from the appended claims or the equivalents thereof. Any of the foregoing embodiments can be implemented in combination with each other. For example, the order of operations and the order of processes mentioned in the foregoing embodiments are merely examples, and the present disclosure is not limited thereto. The same applies to numerical values or mathematical formulas that are used in the description of the foregoing embodiments, if any.

### EXPLANATION OF REFERENCE NUMERALS

1: Machining system
10: Machining device
11: Machining head
12: Workpiece holding unit
13: Drive mechanism
14: Gap detector
20: Numerical control device
21: Movement control unit
22: Ideal specification value group calculation unit
23: Execution specification value group calculation unit
24: Gap control unit
25: Output adjustment unit

1. A numerical control device for controlling a machining device including a machining head that machines a workpiece, a drive mechanism that moves the workpiece and the machining head relative to each other, and a gap detector that detects a distance between the workpiece and the machining head, the numerical control device comprising:
a movement control unit configured to move the workpiece and the machining head relative to each other so as to change a position of a machining point on the workpiece where the machining is performed by the machining head;
an ideal specification value group calculation unit configured to calculate an ideal specification value group for each control cycle based on a value detected by the gap detector, the ideal specification value group being a specification value group including one or more numerical values that specify a position where the machining head is offset by a preset distance in a direction perpendicular to a surface of the workpiece from the machining point; and
an execution specification value group calculation unit configured to calculate an execution specification value group based on the ideal specification value group, the execution specification value group being a specification value group that indicates a position where the machining head is actually placed, wherein
the execution specification value group calculation unit sets the execution specification value group in a current cycle to the same specification value group as the ideal specification value group in the current cycle if an evaluation value indicating a relationship of the ideal specification value group in the current cycle to the execution specification value group in an immediately preceding cycle is equal to or less than a predetermined reference value, and sets the execution specification value group in the current cycle to a specification value group that allows the distance from the machining point to be the preset distance and the evaluation value to be equal to the reference value if the evaluation value of the ideal specification value group in the current cycle is greater than the reference value.

2. The numerical control device according to claim 1, wherein
the ideal specification value group and the execution specification value group are each a vector from the machining point to the position of the machining head.

3. The numerical control device according to claim 2, wherein
the evaluation value is an angular difference between the vector corresponding to the ideal specification value group and the vector corresponding to the execution specification value group.

4. The numerical control device according to claim 3, wherein
the reference value is calculated from a value set as an upper limit value of the distance between the position of the machining head indicated by the ideal specification value group in the current cycle and the position of the machining head indicated by the execution specification value group in the immediately preceding cycle.

5. The numerical control device according to claim 1, further comprising
an output adjustment unit configured to calculate a moving speed of the machining point at the moment the machining head passes through the position indicated by the execution specification value group, and adjust an output of the machining head, taking into account the moving speed of the machining point.
